(19) United States
(12) Patent Application Publication
(10) Pub. No.: US 2025/0105448 A1
(43) Pub. Date: Mar. 27, 2025

(54) SEPARATOR FOR RECHARGEABLE LITHIUM BATTERY AND RECHARGEBALE LITHIUM BATTERY INCLUDING SAME

(71) Applicant: SAMSUNG SDI CO., LTD., Gyeonggi-do (KR)

(72) Inventors: Dongwan SEO, Gyeonggi-do (KR); Jinyoung KIM, Gyeonggi-do (KR); Hyeonseon CHOI, Gyeonggi-do (KR)

(73) Assignee: SAMSUNG SDI CO., LTD., Gyeonggi-do (KR)

(21) Appl. No.: 18/834,036

(22) PCT Filed: Feb. 20, 2023
(86) PCT No.: PCT/KR2023/002399

§ 371 Date: Jul. 29, 2024

(30) Foreign Application Priority Data
Apr. 15, 2022 (KR) 10-2022-0047168

(51) Int. Cl. H01M 50/446; H01M 50/414; H01M 50/434; H01M 50/491

(52) U.S. Cl. CPC H01M 50/446; H01M 50/414; H01M 50/434; H01M 50/491

(57) ABSTRACT

A separator for a rechargeable lithium battery and a rechargeable lithium battery including the same are provided, and the separator for the rechargeable lithium battery includes a porous substrate and a coating layer on at least one surface of the porous substrate and including polyethylene particles and ceramics. The content of the polyethylene particles is 40 to 65 wt % by weight of the content of the porous substrate, the weight-average molecular weight of the polyethylene particles ranges from 1000 g/mol to 3000 g/mol, and the mixing ratio (ratio by weight) of the polyethylene particles to the ceramics ranges from 95:5 to 80:20.

### TECHNICAL FIELD

It relates to a separator for a rechargeable lithium battery and a rechargeable lithium battery including the same.

### BACKGROUND ART

Rechargeable lithium batteries have a high discharge voltage and high energy density, and are attracting attention as a power source for various electronic devices.

A rechargeable lithium battery is arranged so that the positive and negative electrodes may face each other, has a structure filled with an electrolyte solution, and a separator is located between the positive and negative electrodes to prevent short circuit. The separator may be a porous material that may transfer ions or electrolytes.

If a battery is exposed to a high temperature environment due to abnormal behavior, a separator may mechanically shrink or be damaged due to melting characteristics at a low temperature. Herein, the positive and negative electrodes contact each other and may cause an explosion of the battery. In order to solve the problems, technology is needed to suppress shrinkage of the separator and ensure the safety of the battery.

### Technical Problem

One embodiment is to provide a separator for a rechargeable lithium battery with excellent safety.

Another embodiment provides a rechargeable lithium battery including the separator.

### Technical Solution

According to one embodiment, a separator for a rechargeable lithium battery including a porous substrate; a coating layer positioned on at least one surface of the porous substrate and including polyethylene particles and ceramics, wherein an amount of the polyethylene particles is 40 wt % to 65 wt % of the weight of the porous substrate, a weight average molecular weight (Mw) of the polyethylene particles is 1000 g/mol to 3000 g/mol, and a mixing ratio of the polyethylene particles and the ceramics is 95:5 to 80:20 by weight ratio.

The polyethylene particles may have an average size of 0.1 μm to 3.0 μm.

The coating layer may have a thickness of 0.5 μm to 5 μm on one side.

The ceramics may have an average size of 0.5 μm to 3.0 μm.

The ceramics may be Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof

The coating layer may include a binder

The separator may further include an adhesive layer on one surface of the coating layer.

The adhesive layer may include a binder and a filler.

According to one embodiment, a rechargeable lithium battery including a negative electrode including a negative active material; a positive electrode including a positive active material; the separator between the negative electrode and the positive electrode; and a non-aqueous electrolyte.

Details of other embodiments are included in the detailed description below.

### Advantageous Effects

A separator for a rechargeable lithium battery according to one embodiment may exhibit excellent safety

### BRIEF DESCRIPTION OF THE DRAWINGS

FIG. 1 is a view briefly showing a rechargeable lithium battery according to an embodiment.

### BEST MODE FOR PERFORMING INVENTION

Hereinafter, embodiments of the present invention are described in detail. However, these embodiments are exemplary, the present invention is not limited thereto and the present invention is defined by the scope of claims. The terminology used herein is used to describe embodiments only, and is not intended to limit the present disclosure. The singular expression includes the plural expression unless the context clearly dictates otherwise.

“Combination thereof” means a mixture, laminate, composite, copolymer, alloy, blend, reaction product, and the like of the constituents.

As used herein, it should be understood that terms such as “comprise”, “include” or “have” are intended to designate the presence of an embodied feature, number, step, element, or a combination thereof, but it does not preclude the possibility of the presence or addition of one or more other features, number, step, element, or a combination thereof.

The drawings show that the thickness is enlarged in order to clearly show the various layers and regions, and the same reference numerals are given to similar parts throughout the specification. If an element, such as a layer, a film, a region, a plate, and the like is referred to as being “on” or “over” another part, it may include cases where it is “directly on” another element, but also cases where there is another element in between. In contrast, when an element is referred to as being “directly on” another element, there are no intervening elements present.

“Thickness” may be measured, for example, through an image taken with an optical microscope such as a scanning electron microscope.

The average size may refer to an average particle diameter (D50), and in the present specification, when a definition is not otherwise provided, an average particle diameter (D50) indicates a particle where a cumulative volume is about 50 volume % in a particle distribution.

The average particle size (D50) may be measured by a method well known to those skilled in the art, for example, by a particle size analyzer, or by a transmission electron microscopic image, or a scanning electron microscopic image. In some embodiments, a dynamic light-scattering measurement device is used to perform a data analysis, and the number of particles is counted for each particle size range, and from this, the average particle diameter (D50) value may be easily obtained through a calculation.

One embodiment includes a porous substrate, and a coating layer positioned on at least one surface of the porous substrate and including polyethylene particles and ceramics. Herein, an amount of the polyethylene particles is 40 wt % to 65 wt % of the weight of the porous substrate, a weight average molecular weight (Mw) of the polyethylene particles may be 1000 g/mol to 3000 g/mol, and a mixing ratio of the polyethylene particles and the ceramics may be 95:5 to 80:20 by weight ratio.

The polyethylene particles do not melt during normal charging and discharging within the battery, but if a high temperature phenomenon occurs within the battery, they melt before the porous substrate above the melting temperature and block the pores within the porous substrate to block the movement of ions, induce a quick shutdown function, and ensure the safety of the rechargeable battery. To explain this in more detail, the melting temperature of polyethylene particles is 100° C. to 120° C., which is approximately 30° C. lower than the melting temperature of the porous substrate, and thus, if a high temperature phenomenon occurs in the battery, they may melt before the porous substrate.

Such a shutdown effect by melting the polyethylene particles may be effectively obtained if the weight-average molecular weight (Mw) of the polyethylene particles is 1000 g/mol to 3000 g/mol. This may be because the weight-average molecular weight of the polyethylene particles within the range provides the size of the polyethylene particles corresponding to an appropriate size for effectively blocking pores in the porous substrate.

If the weight-average molecular weight of the polyethylene particles is out of the range, although the polyethylene particles are melted, it is not sufficient to block the pores in the porous substrate, or it is difficult to insert into the pores in the porous substrate, making it inappropriate.

In one embodiment, the polyethylene particles having the weight average molecular weight may be in a wax form.

For sufficiently blocking such polyethylene particles in pores of the porous substrate, it is suitable to adjust the amount of the polyethylene particles included in the coating layer based on the weight of the porous substrate.

If the amount of the polyethylene particles is 40 wt % to 65 wt % of the weight of the porous substrate, the pores in the porous substrate may be sufficiently blocked, if a high temperature phenomenon occurs. The amount of the polyethylene particles, for example, may be 40 wt % to 60 wt % of the weight of the porous substrate, or 44 wt % to 60 wt %

If the amount of the polyethylene particles is smaller than the range it is insufficient to block the pores and if it is larger than 65 wt %, too amount of the polyethylene particles may adversely affect to increase the air permeability.

In addition, if the mixing ratio of the polyethylene particles and the ceramics is within the range, the physical safety effects such as dropping, penetration, or the like may be excellent.

In one embodiment, the average size of the polyethylene particles may be 0.1 μm to 3.0 μm. More specifically, the average size of the polyethylene particles may be 0.1 μm to 2.0 μm, 0.5 μm to 2.0 μm, for example 0.5 μm to 1.5 μm, 1.0 μm to 1.5 μm, 1.0 μm to 1.4 μm, or 1.1 μm to 1.3 μm. If the average size of the polyethylene particle is within the range, the pores presented in the porous substrate may be effectively blocked, if a high temperature phenomenon occurs.

A thickness of the coating layer on one side may be 0.5 μm to 5 μm, for example 1 μm to 5 μm, 1 μm to 4 μm, 1 μm to 3 μm, 1 μm to 2 μm. The coating layer may be formed on one side or both sides of the porous substrate, and because such a thickness indicates a thickness on one side, if it is formed on both sides, it may be 1 μm to 10 μm, 2 μm to 10 μm, 2 μm to 8 μm, 2 μm to 6 μm, 2 μm to 4 μm. If the thickness of the coating layer on one side is within the range, the movement of lithium ions may occur smoothly and the shutdown effects may be significantly exhibited, thereby further enhancing safety, if a high temperature phenomenon occurs. Furthermore, the resistance of the separator and the binding force of the coating layer to the porous substrate may be maintained at an appropriate level.

An average size of the ceramics may be 0.5 μm to 3.0 μm, 0.5 μm to 2.0 μm, 0.5 μm to 1.0 μm, 550 nm to 750 nm, 600 nm to 750 nm, or 600 nm to 700 nm. If the average size of the ceramics is within the range, the coating layer having more suitable air permeability and suitable packing density may be formed.

In one embodiment, the shape of the polyethylene particles may be cubic shape, plate shape, spherical shape, or unspecified shape, and its shape does not need to be limited.

In addition, the ceramic may be cubic, plate-shaped, spherical, or unspecified shape, and its shape does not need to be limited.

The ceramics may be Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

The coating layer may further include a binder. The binder may be a dispersed binder, a curable binder, or an aqueous binder.

The dispersion binder may be sodium polyacrylate, ammonium polyacrylate, potassium polyacrylate, or a combination thereof. An amount of the dispersion binder may be adjusted appropriately, and for example, the amount of the dispersion binder may be 0.5 wt % to 2 wt % or 1 wt % to 2 wt % based on a weight of the ceramics, but there is no need to be limited thereto.

The aqueous binder may include, for example, a styrene-butadiene rubber, an acrylated styrene-butadiene rubber, polyvinyl alcohol, sodium polyacrylate, a copolymer of propylene and a C2 to C8 olefin, poly acrylamide, a copolymer of (meth)acrylic acid and (meth)acrylic acid alkyl ester, or a combination thereof.

In the coating layer, an amount of the aqueous binder may be, based on the total 100 wt % of the coating layer, 1 wt % to 10 wt %, 2 wt % to 8 wt %, 3 wt % to 8 wt %, or 3 wt % to 5 wt %. If an amount of the aqueous binder is within the above range, the adhesion between the coating layer and the porous substrate may be maintained more appropriately, and the resistance of the separator may be maintained at an appropriate level.

The curable binder may be polyglycidyl ether, isocyanate, epoxy, or a combination thereof.

In another embodiment, the curable binder may be at least one of an acrylic copolymer and a fluorine-based binder.

The acrylic copolymer may be in the form of particles, and the fluorine-based binder may also be in the form of particles. In one embodiment, (meth)acrylic may mean acrylic or methacrylic.

The acrylic copolymer may be a (meth)acrylic copolymer, for example, a (meth)acrylic copolymer having a core-shell structure. Specifically, it may be a (meth)acrylic polymer including a structural unit derived from (meth)acrylic acid or (meth)acrylate and a structural unit derived from a monomer including a polymerizable unsaturated group.

More specifically, the core of the (meth)acrylic adhesive binder may include a structural unit derived from (meth)acrylic acid or (meth)acrylate, and the shell of the (meth)acrylic adhesive binder may include a structural unit derived from a monomer including a polymerizable unsaturated group.

The monomer including the polymerizable unsaturated group included in the shell of the (meth)acrylic adhesive binder may be at least one selected from a styrene-based monomer, an acid-derived monomer, and a combination thereof.

Specifically, the styrene-based monomer may include at least one aromatic vinyl monomer represented by Chemical Formula 10.

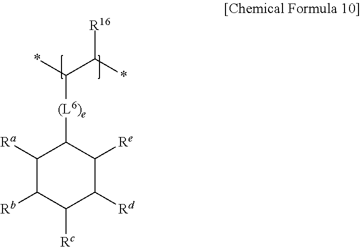

In Chemical Formula 10,
R¹⁶ is hydrogen or a C1 to C6 alkyl group,
R^{a} to R^{e} are each independently hydrogen or C1 to C6 alkyl,
L⁶ is a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group,
e is one of the integers from 0 to 2, and,
* is a linking point.

More specifically, the styrene-based monomer may be at least one selected from methyl styrene, bromo styrene, chloro styrene, and a combination thereof as well as styrene.

More specifically, the acid-derived monomer may include a substituent corresponding to —COOH and may be at least one selected from itaconic acid, (meth)acrylic acid, and a combination thereof.

For example, the acrylic copolymer may be an acrylic copolymer including a repeating unit derived from a (meth)acrylate-based monomer. In addition, the acrylic copolymer may further include repeating units derived from an acetate group-containing monomer in addition to repeating units derived from the (meth)acrylate-based monomer.

The usable acrylic copolymer including a repeating unit derived from the (meth)acrylate-based monomer and/or a repeating unit derived from the acetate group-including monomer are not particularly limited as long as they may form good adhesion at the pressing temperature between the positive electrode and negative electrode, but the acrylic copolymer may be for example a copolymer prepared by polymerizing one or more (meth)acrylate-based monomers selected from butyl (meth)acrylate, propyl (meth)acrylate, ethyl (meth)acrylate, and methyl (meth)acrylate. Alternatively, the acrylic copolymer may be a copolymer produced by polymerizing one or more (meth)acrylate-based monomers selected from butyl (meth)acrylate, propyl (meth)acrylate, ethyl (meth)acrylate, and methyl (meth)acrylate, and one or more acetate group-containing monomers selected from vinyl acetate and allyl acetate.

The repeating unit derived from the acetate group-containing monomer may be the repeating unit of Chemical Formula 11.

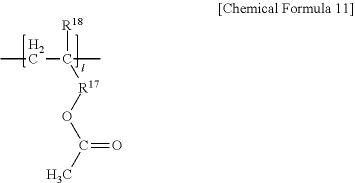

(In Chemical Formula 11,
R¹⁷ is a single bond or linear or branched alkyl having 1 to 6 carbon atoms, R¹⁸ is hydrogen or methyl, and I is each an integer between 1 and 100)

For example, the repeating unit derived from the acetate group-containing monomer may be a repeating unit derived from one or more acetate group-containing monomers selected from vinyl acetate and allyl acetate. The acrylic copolymer may be prepared by polymerizing (meth)acrylate-based monomers, or may be prepared by polymerizing (meth)acrylate-based monomers and other monomers other than (meth)acrylate-based monomers. For example, the other monomers may be an acetate group-containing monomer. In this case, the (meth)acrylate monomer and other monomers, specifically the acetate group-containing monomer, may be polymerized at a molar ratio of 3:7 to 7:3, specifically 4:6 to 6:4, and more specifically about 5:5. The acrylic copolymer may be prepared by a polymerization reaction, for example, of a butyl (meth)acrylate monomer, a methyl (meth)acrylate monomer, and a vinyl acetate and/or allyl acetate monomer at a molar ratio of 3 to 5:0.5 to 1.5:4 to 6, specifically at a molar ratio of 4:1:5.

The acrylic copolymers may be crosslinked or non-crosslinked. To prepare a crosslinked acrylic copolymer, a crosslinking agent may be further added during the polymerization step.

The glass transition temperature (Tg) of the acrylic copolymer may be 110° C. or less, and may be 20° C. to 110° C.

Within the above range, not only is electrode adhesion more excellent, but also better ionic conductivity may be exhibited.

A particle size of the acrylic copolymer may be 0.2 μm to 1.0 μm, specifically 0.2 μm to 0.7 μm, for example 0.3 μm to 0.7 μm or 0.4 μm to 0.7 μm. The particle size may be adjusted by controlling an addition amount of an initiator, an addition amount of an emulsifier, a reaction temperature, and a stirring speed.

The fluorine-based binder may specifically include a polyvinylidene fluoride (PVdF) homopolymer or a copolymer of vinylidene fluoride and another monomer.

Another monomer that may be copolymerized with the vinylidene fluoride to form a copolymer may be one or more selected from chlorotrifluoroethylene, trifluoroethylene, hexafluoropropylene, ethylene tetrafluoride, and ethylene monomer. For example, the copolymer may be a polyvinylidene fluoride-hexafluoropropylene (PVdF-HFP) copolymer including a unit derived from a vinylidene fluoride monomer and a unit derived from a hexafluoropropylene monomer.

A weight average molecular weight of the fluorine-included binder may be 100,000 g/mol to 1,500,000 g/mol, or for example, 300,000 g/mol to 800,000 g/mol. If the weight average molecular weight of the fluorine-included binder satisfies the above range, the fluorine-included adhesive binder and a separator including the same may exhibit excellent adhesion, heat resistance, air permeability, and oxidation resistance.

The weight average molecular weight may be a polystyrene-reduced average molecular weight measured using gel permeation chromatography.

A glass transition temperature (Tg) of the fluorine-included binder may be −45° C. to −35° C., for example, −42° C. to −38° C., and a melting point may be 100° C. to 180° C., for example, 130° C. to 160° C. If the glass transition temperature and melting point of the fluorine-included binder satisfy the above ranges, the fluorine-included binder and the separator including the same may exhibit excellent adhesion, heat resistance, air permeability, and oxidation resistance. The glass transition temperature may be a value measured by differential scanning calorimetry.

A particle size of the fluorine-included binder may be 100 nm to 500 nm, or for example, 150 nm to 300 nm.

The particle diameter may be adjusted by controlling an addition amount of an initiator, an addition amount of an emulsifier, a reaction temperature, and a stirring speed.

In the coating layer, an amount of the curable binder may be 0.25 wt % to 3 wt %, 0.25 wt % to 2 wt %, 0.5 wt % to 2 wt %, 0.5 wt % to 1.5 wt %, or 0.5 wt % to 1 wt % based on 100 wt % of the coating layer. If the amount of the curable binder is within the above range, side reactions may not occur in the battery because there is no curable binder remaining after curing.

The separator may further include an adhesive layer on one surface of the coating layer.

The adhesive layer may include a binder and filler.

In this specification, ‘(meth)acrylic’ means acrylic or methacrylic.

The binder may be (meth)acrylic acid, (meth)acrylate, (meth)acrylonitrile, (meth)acrylamidosulfonic acid, a (meth)acrylamidosulfonic acid salt, styrene, ethylhexyl acrylate, a combination thereof, or a copolymer thereof.

The filler may be polyvinylidene fluoride, a polyvinylidene fluoride-hexafluoropropylene copolymer, polytetrafluoroethylene, or a combination thereof.

A mixing ratio of the binder and filler in the adhesive layer may be 1:1 to 1:5 by weight, 1:1 to 1:3 by weight, or 1:1 to 1:2 by weight. If the binder:filler mixing ratio is within the above range, superior adhesion may be achieved without increasing resistance.

A thickness of the adhesive layer on one side may be 0.1 μm to 4.0 μm, for example, 0.1 μm to 3.0 μm, 0.1 μm to 2.0 μm, 0.1 μm to 1.0 μm, for example, 0.3 μm to 1.0 μm, 0.4 μm to 1.0 μm, 0.4 μm to 0.9 μm, or 0.5 μm to 0.9 μm.

The porous substrate has a large number of pores and may be a substrate commonly used in batteries. The porous substrate may include any one selected from polyolefin such as polyethylene and polypropylene, polyester such as polyethylene terephthalate and polybutylene terephthalate, polyacetal, polyamide, polyimide, polycarbonate, polyetheretherketone, polyaryletherketone, polyetherimide, polyamideimide, polybenzimidazole, polyethersulfone, polyphenyleneoxide, a cyclic olefin copolymer, polyphenylenesulfide, polyethylenenaphthalate, a glass fiber, TEFLON, and polytetrafluoroethylene, or a copolymer or mixture of two or more types thereof.

The porous substrate may have a thickness of 1 μm to 40 μm, for example 1 μm to 30 μm, 1 μm to 20 μm, 5 μm to 15 μm, or 5 μm to 10 μm.

As such, the separator according to one embodiment includes the coating layer including polyethylene particles and the first ceramics at a specific weight ratio, and includes the second ceramics and the binder at a specific weight ratio, and the binder includes polyvinylidene fluoride and the polyvinylidene-hexapropylene copolymer at a specific weight ratio, and the first ceramics the second ceramics have different average sizes. The separator with the such a combination may exhibit excellent adherence to the electrode and better air permeability, leading readily lithium movement.

A separator for a lithium secondary battery according to an embodiment may be manufactured by various known methods. For example, a separator for a lithium secondary battery is formed by coating a composition for forming a coating layer on one or both surfaces of a porous substrate and then drying it to form a coating layer, and coating a composition for forming an adhesive layer on one surface of the coating layer and then drying it to form an adhesive layer.

The composition for forming the coating layer may include ceramics, polyethylene particles, and a solvent, and may further include a binder. The solvent is not particularly limited as long as it may dissolve or disperse the ceramics and polyethylene particles and the binder. In one embodiment, the solvent may be an aqueous solvent including water, alcohol, or a combination thereof. The alcohol may be methyl alcohol, ethyl alcohol, propyl alcohol, or a combination thereof.

The composition for forming a coating layer may be prepared by adding ceramics and a dispersion binder to a solvent and mixing them to prepare a ceramic/binder liquid, and adding and mixing polyethylene, a curable binder, an aqueous binder, and a solvent to the ceramic/binder liquid. The dispersion binder may be used in a solid or liquid form, the aqueous binder may also be used in a solid or liquid form, and the curable binder may also be used in a solid or liquid form. If the dispersion binder, the aqueous binder, and the curable binder are used in a liquid form, the solvent may be an aqueous solvent including water, alcohol, or a combination thereof. The alcohol may be methyl alcohol, ethyl alcohol, propyl alcohol, or a combination thereof.

Additionally, the polyethylene particles may be used in solid or liquid form. If polyethylene particles are used in a liquid form, the solvent may be an aqueous solvent including water, alcohol, or a combination thereof. The alcohol may be methyl alcohol, ethyl alcohol, propyl alcohol, or a combination thereof.

If the dispersion binder is used in a liquid form, a concentration thereof may be 30 wt % to 50 wt %, and when the aqueous binder is used in a liquid form, a concentration may be 7.5 wt % to 9.5 wt %. Additionally, when the curable binder is used in liquid form, a concentration thereof may be 15 wt % to 25 wt %. In addition, when polyethylene particles are used in liquid form, a concentration thereof may be 30 wt % to 50 wt %.

The dispersion binder may be the dispersion binder described above, the aqueous binder may be the aqueous binder described above, and the curable binder may be the curable binder described above.

In the composition for forming a coating layer, a mixing ratio of the materials used can be adjusted appropriately, and there is no need to specifically limit it.

Additionally, the mixing process may be performed through a milling process such as a bead mill or ball mill, but is not limited thereto.

The coating may be performed by, for example, spin coating, dip coating, bar coating, die coating, slit coating, roll coating, inkjet printing, etc., but is not limited thereto.

The drying may be performed by, for example, natural drying, drying with warm air, hot air or low humidity air, vacuum drying, irradiation with far-infrared rays, electron beams, etc., but is not limited thereto. The drying process may be performed at a temperature of, for example, 25° C. to 120° C.

The composition for forming an adhesive layer may include a binder, filler, and solvent. The solvent may be an aqueous solvent including water, alcohol, or a combination thereof. The alcohol may be methyl alcohol, ethyl alcohol, propyl alcohol, or a combination thereof. The binder and the filler are as described above.

Another embodiment provides a rechargeable lithium battery including a negative electrode, a positive electrode, a separator between the negative electrode and the positive electrode, and an electrolyte.

The separator is a separator according to one embodiment.

The negative electrode includes a current collector and a negative electrode active material layer formed on the current collector and including the negative electrode active material.

The negative electrode active material may be a material that reversibly intercalates/deintercalates lithium ions, a lithium metal, a lithium metal alloy, a material capable of doping/dedoping lithium, or a transition metal oxide.

Examples of the material that reversibly intercalates/deintercalates lithium ions include a carbon material, that is, a carbon-based negative electrode active material commonly used in lithium secondary batteries. Representative examples of carbon-based negative electrode active materials include crystalline carbon, amorphous carbon, or a combination thereof. Examples of the crystalline carbon may include graphite such as unspecified-shape, plate-shaped, flake, spherical or fibrous natural graphite or artificial graphite, and examples of the amorphous carbon may include soft carbon, hard carbon, mesophase pitch carbonized product, sintered coke, or the like.

The lithium metal alloy may include an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be Si, SiOₓ (0<x<2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, but not Si), a Si-carbon composite, Sn, SnO₂, a Sn—R alloy (wherein R is an element selected from an alkali metal, an alkaline-earth metal, a Group 13 element, a Group 14 element, a Group 15 element, a Group 16 element, a transition metal, a rare earth element, and a combination thereof, but not Sn), a Sn-carbon composite, and the like, and additionally, at least one of these may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, and a combination thereof.

The titanium metal oxide may be lithium titanium oxide.

The negative electrode active material according to an embodiment may include a Si—C composite including a Si-included active material and a carbonaceous active material.

The Si-included active material may be Si, SiOₓ (0<x<2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, but not Si), or a combination thereof.

An average particle diameter of the Si-included active material may be 50 nm to 200 nm.

If the average particle diameter of the Si-included active material is within the above range, volume expansion that occurs during charging and discharging may be suppressed, and disconnection of the conductive path due to particle crushing during charging and discharging can be prevented.

The Si-included active material may be included in an amount of 1 wt % to 60 wt %, for example 3 wt % to 60 wt %, based on a total weight of the Si—C composite.

The negative electrode active material according to another embodiment may further include crystalline carbon along with the Si—C composite described above.

If the negative active material includes a Si—C composite and crystalline carbon, the Si—C composite and crystalline carbon may be included in the form of a mixture, in which case the Si—C composite and crystalline carbon may be included in a weight ratio of 1:99 to 50:50. More specifically, the Si—C composite and crystalline carbon may be included in a weight ratio of 5:95 to 20:80.

The crystalline carbon may include, for example, graphite, and more specifically, may include natural graphite, artificial graphite, or a mixture thereof.

An average particle diameter of the crystalline carbon may be 5 μm to 30 μm.

In this specification, the average particle diameter may be the particle size (D50) at 50 volume % in the cumulative size-distribution curve. The average particle size (D50) can be measured by methods well known to those skilled in the art, for example, using a particle size analyzer, a transmission electron microscope photograph, or a scanning electron microscope. In another embodiment, a dynamic light-scattering measurement device is used to perform a data analysis, and the number of particles is counted for each particle size range. From this, the average particle diameter (D50) value may be easily obtained through a calculation.

The Si—C composite may further include a shell surrounding the surface of the Si—C composite, and the shell may include amorphous carbon. The thickness of the shell may be 5 nm to 100 nm.

The amorphous carbon may include soft carbon, hard carbon, mesophase pitch carbide, calcined coke, or mixtures thereof.

The amorphous carbon may be included in an amount of 1 part by weight to 50 parts by weight, for example, 5 parts by weight to 50 parts by weight, or 10 parts by weight to 50 parts by weight, based on 100 parts by weight of the carbon-based active material.

The negative active material layer includes a negative active material and a binder, and may optionally further include a conductive material.

In the negative electrode active material layer, the negative active material may be included in an amount of 95 wt % to 99 wt % based on the total weight of the negative active material layer. An amount of the binder in the negative active material layer may be 1 wt % to 5 wt % based on a total weight of the negative active material layer. In addition, if a conductive material is further included, 90 wt % to 98 wt % of the negative electrode active material, 1 wt % to 5 wt % of the binder, and 1 wt % to 5 wt % of the conductive material may be used.

The binder serves to well attach the negative electrode active material particles to each other and also to well attach the negative electrode active material to the current collector. The binder may be a non-water-soluble binder, a water-soluble binder, or a combination thereof.

The non-water-soluble binder may be an ethylene propylene copolymer, polyacrylonitrile, polystyrene, polyvinyl chloride, carboxylated polyvinylchloride, polyvinyl fluoride, polyurethane, polytetrafluoroethylene, polyvinylidene fluoride, polyethylene, polypropylene, polyamideimide, polyimide, or a combination thereof.

The water-soluble binder may be a styrene-butadiene rubber, an acrylated styrene-butadiene rubber, an acrylonitrile-butadiene rubber, an acrylic rubber, a butyl rubber, a fluoro rubber, an ethylene oxide-containing polymer, polyvinyl pyrrolidone, polyepichlorohydrin, polyphosphazene, an ethylene propylene diene copolymer, polyvinyl pyridine, chlorosulfonated polyethylene, latex, a polyester resin, an acrylic resin, phenolic resin, an epoxy resin, polyvinyl alcohol, or a combination thereof.

If a water-soluble binder is used as the negative electrode binder, a cellulose-based compound capable of imparting viscosity may be further included as a thickener. The cellulose-based compound may include one or more types of carboxymethyl cellulose, hydroxypropylmethyl cellulose, methyl cellulose, or alkali metal salts thereof. The alkali metal may be Na, K, or Li. An amount of the thickener used may be 0.1 parts by weight to 3 parts by weight based on 100 parts by weight of the negative electrode active material.

The conductive material is used to impart conductivity to the electrode, and any material may be used as long as it does not cause chemical change in the battery to be configured and is an electron conductive material. Examples of the conductive material may be a carbon-based material such as natural graphite, artificial graphite, carbon black, acetylene black, ketjen black, denka black, a carbon fiber, and the like; a metal-based material of a metal powder or a metal fiber including copper, nickel, aluminum, silver, and the like; a conductive polymer such as a polyphenylene derivative; or a mixture thereof.

The current collector may include one selected from a copper foil, a nickel foil, a stainless steel foil, a titanium foil, a nickel foam, a copper foam, a polymer substrate coated with a conductive metal, and a combination thereof.

The positive electrode includes a current collector and a positive active material layer formed on the current collector and including a positive active material.

The positive electrode active material may include lithiated intercalation compounds that reversibly intercalate and deintercalate lithium ions, specifically one or more composite oxides of a metal selected from cobalt, manganese, nickel, and a combination thereof, and lithium. As a more specific example, a compound represented by any one of the following chemical formulas may be used. LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}D_{α} (0.90≤a≤1.8, 0≤b≤0.5, 0≤c≤0.5, 0<α≤2); LiₐNi_{1-b-c}Co_{b}X_{c}O_{2-α}T_{α} (0.90≤a≤1.8, 0≤b≤0.5, 0≤c≤0.5, 0<α<2); LiₐNi_{1-b-c}Co_{b}X_{c}O_{2-α}T₂ (0.90≤a≤1.8, 0≤b≤0.5, 0≤c≤0.5, 0<α<2); LiₐNi_{1-b-c}Mn_{b}X_{c}D_{α} (0.90≤a≤1.8, 0≤b≤0.5, 0≤c≤0.5, 0<α≤2); LiₐNi_{1-b-c}Mn_{b}X_{c}O_{2-α}T_{α} (0.90≤a≤1.8, 0≤b≤0.5, 0≤c≤0.5, 0<α<2); LiₐNi_{1-b-c}Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8)

In the above chemical formulas, A is selected from Ni, Co, Mn, and a combination thereof; X is selected from Al, Ni, Co, Mn, Cr, Fe, Mg, Sr, V, rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound, and for example, the method may include any coating method (e.g., spray coating, dipping, etc.), but is not illustrated in more detail since it is well-known to those skilled in the related field.

In the positive electrode, an amount of the positive active material may be 90 wt % to 98 wt % based on a total weight of the positive active material layer.

In an embodiment, the positive electrode active material layer may further include a binder and a conductive material. At this time, each amount of the binder and the conductive material may each be 1 wt % to 5 wt % based on a total weight of the positive electrode active material layer.

The binder serves to well attach the positive active material particles to each other and also to well attach the positive active material to the current collector, and examples thereof may be polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is used to impart conductivity to the electrode, and any material may be used as long as it does not cause chemical change in the battery to be configured and is an electron conductive material. Examples of the conductive material may include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The current collector may be aluminum foil, nickel foil, or a combination thereof, but is not limited thereto.

The positive active material layer and the negative active material layer are formed by mixing an active material, a binder, and optionally a conductive material in a solvent to prepare an active material composition, and coating this active material composition on a current collector. This method of forming an active material layer is widely known in the art and thus detailed description will be omitted in this specification. The solvent includes N-methyl pyrrolidone and the like, but is not limited thereto. Additionally, when an aqueous binder is used in the negative active material layer, water may be used as a solvent used in preparing the negative active material composition.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, t-butyl acetate, methyl propionate, ethyl propionate, propyl propionate, decanolide, mevalonolactone, caprolactone, and the like. The ether-based solvent may include dibutyl ether, tetraglyme, diglyme, dimethoxyethane, 2-methyltetrahydrofuran, tetrahydrofuran, and the like. In addition, the ketone-based solvent may include cyclohexanone, and the like. The alcohol-based solvent may include ethanol, isopropyl alcohol, and the like and the aprotic solvent may include nitriles such as R—CN (where R is a C2 to C20 linear, branched, or cyclic hydrocarbon, and may include a double bond, an aromatic ring, or an ether bond), amides such as dimethylformamide, dioxolanes such as 1,3-dioxolane, sulfolanes, and the like.

The non-aqueous organic solvents may be used alone or in combination with one or more. If the organic solvent is used in a mixture, the mixture ratio may be controlled in accordance with a desirable battery performance.

The carbonate-based solvent is desirably used by mixing a cyclic carbonate and a chain carbonate. In this case, a mixture of cyclic carbonate and chain carbonate in a volume ratio of 1:1 to 1:9 may result in superior electrolyte solution performance.

If the non-aqueous organic solvent is mixed and used, a mixed solvent of a cyclic carbonate and a chain carbonate, a mixed solvent of a cyclic carbonate and a propionate-based solvent, or a mixed solvent of a cyclic carbonate, a chain carbonate, and a propionate-based solvent may be used. The propionate-based solvent may be methyl propionate, ethyl propionate, propyl propionate, or a combination thereof.

Herein, when the cyclic carbonate and the chain carbonate or the cyclic carbonate and the propionate-based solvent are mixed, they may be mixed in a volume ratio of 1:1 to 1:9 and thus performance of an electrolyte may be improved. In addition, when the cyclic carbonate, the chain carbonate, and the propionate-based solvent are mixed, they may be mixed in a volume ratio of 1:1:1 to 3:3:4. The mixing ratios of the solvents may be appropriately adjusted according to desirable properties.

The non-aqueous organic solvent of the present disclosure may further include an aromatic hydrocarbon-based organic solvent in addition to the carbonate-based solvent. Herein, the carbonate-based solvent and the aromatic hydrocarbon-based organic solvent may be mixed in a volume ratio of 1:1 to 30:1.

The aromatic hydrocarbon-based organic solvent may be an aromatic hydrocarbon-based compound of Chemical Formula 1.

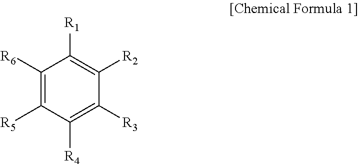

(In Chemical Formula 1, R₁ to R₆ are the same or different and are selected from hydrogen, a halogen, a C1 to C10 alkyl group, a haloalkyl group, and a combination thereof.)

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The non-aqueous electrolyte may further include an additive of vinylene carbonate, or an ethylene carbonate-based compound of Chemical Formula 2 as a cycle-life enhancing additive.

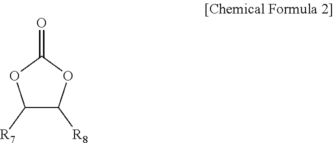

(In Chemical Formula 2, R₇ and R₈ are the same or different, and are selected from hydrogen, a halogen, a cyano group (CN), a nitro group (NO₂), and a fluorinated C1 to C5 alkyl group, provided that at least one of R₇ and R₈ is selected from a halogen, a cyano group (CN), a nitro group (NO₂), and a fluorinated C1 to C5 alkyl group, and R₇ and R₈ are not hydrogen.)

Examples of the ethylene carbonate-based compound may include difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, or the like. If using more of these cycle-life enhancing additives, the amount used may be adjusted appropriately.

The electrolyte may further include vinylethylene carbonate, propane sultone, succinonitrile, or a combination thereof, and the use amount may be adjusted appropriately.

The lithium salt dissolved in an organic solvent supplies a battery with lithium ions, basically operates the lithium secondary battery, and improves transportation of the lithium ions between positive and negative electrodes. Examples of the lithium salt may include one or two selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiPO₂F₂, LiN(CₓF₂ₓ₊₁SO₂)(C_{y}F_{2y+1}SO₂) where x and y are natural numbers, for example integers of 1 to 20, lithium difluoro(bisoxalato)phosphate, LiCl, LiI, LiB(C₂O₄)₂ (lithium bis(oxalato) borate: LiBOB), and lithium difluoro(oxalato) borate (LiDFOB), as a supporting electrolytic salt. A concentration of the lithium salt may range from 0.1 M to 2.0 M. If the lithium salt is included at the above concentration range, an electrolyte may have excellent performance and lithium ion mobility due to optimal electrolyte conductivity and viscosity.

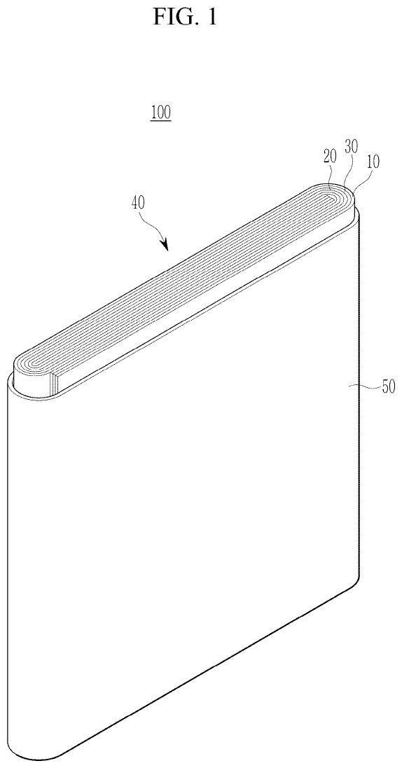

FIG. 1 shows an exploded perspective view of a lithium secondary battery according to an embodiment of the present invention. Although the lithium secondary battery according to an embodiment is described as an example of a prismatic shape, the present invention is not limited thereto and may be applied to batteries of various shapes, such as cylindrical and pouch types.

Referring to FIG. 1, a lithium secondary battery 100 according to an embodiment may include an electrode assembly 40 manufactured by winding a separator 30 disposed between a positive electrode 10 and a negative electrode 20 and a case 50 housing the electrode assembly 40. An electrolyte solution (not shown) may be impregnated in the positive electrode 10, the negative electrode 20 and the separator 30.

### MODE FOR PERFORMING THE INVENTION

Hereinafter, examples of the present invention and comparative examples are described. These examples, however, are not in any sense to be interpreted as limiting the scope of the invention.

In the following examples and comparative examples, % concentration means wt %.

### Example 1

### 1. Preparation of Separator

2077.5 g of distilled water and 22.5 g of a poly acrylic acid sodium aqueous solution at a concentration of 40% as a dispersion binder were added to 900 g of cubic boehmite with an average particle size (D50) of 0.65 μm (Anhui Estone Materials Technology Co., Ltd.) and the mixture was milled with a bead mill at 25° C. for 30 minutes to prepare 3000 g of boehmite-binder dispersion with a solid amount of 30 wt %.

10.82 g of the prepared boehmite-binder dispersion, 32.47 g of a polyethylene (PE) particles aqueous solution at a concentration of 40% (weight average molecular weight (Mw) of polyethylene particles: 1500 g/mol, average particle size (D50) of polyethylene wax: 1 μm, and a melting temperature of the polyethylene wax: 113° C.), 0.81 g of a polyglycidyl ether binder aqueous solution at a concentration of 18.9%, 48.52 g of distilled water, and 7.37 g of a polyacryl amide aqueous solution at a concentration of 8.3% were mixed and then, stirred for 1 hour, preparing a coating liquid.

The coating liquid was die-coated on both sides of a 5.5 μm-thick polyethylene porous substrate (air permeability: 113 sec/100 cc, puncture strength: 280 kgf, a melting temperature: 143° C., SK ie technology Co., Ltd.) at a thickness on both sides of 4 μm (each 2 μm on one side) and then, dried at 70° C. for 10 minutes to form a coating layer with a thickness of 4 μm on both sides.

### 2) Formation of Adhesive Layer

An acrylonitrile-styrene-ethylhexylacrylate copolymer binder and a polyvinylidene fluoride were mixed in a weight ratio of 1:1 in water to prepare a composition for an adhesive layer, and the composition for the adhesive layer was die-coated on both sides of the coating layer at a thickness on one side of 0.5 μm and then dried at 70° C. for 10 minutes to prepare an adhesive layer with the thickness on one side of 0.5 μm, thereby preparing a separator. As a result, the obtained separator had a five-layered structure of the porous substrate, the coating layers formed on both surfaces of the porous substrate, and the adhesive layers formed on the surface of the coating layer in contact with the porous substrate and its opposite surface thereof. Herein, an amount of polyethylene wax particles included in the separator was 2 g.

### 2. Fabrication of Half-Cell

94 wt % of artificial graphite, 3 wt % of Ketjen black, and 3 wt % of polyvinylidene fluoride were mixed in an N-methyl pyrrolidone solvent to prepare a negative active material layer composition, and the negative active material layer composition was coated on a copper current collector and then, dried and pressurized to prepare a negative electrode.

The negative electrode, the manufactured separator, and a lithium metal counter electrode were stacked, which was used with an electrolyte to manufacture a half-cell in a common method. The electrolyte as prepared by dissolving 1.5 M LiPF₆ in a mixed solvent of ethylene carbonate, ethylmethyl carbonate, and dimethyl carbonate (in a volume ratio of 2:1:7).

### Example 2

A separator for a lithium secondary battery was manufactured in the same manner as in Example 1 except that the coating liquid prepared by Example 1 was die-coated on both sides of a 5.5 μm thickness polyethylene porous substrate to be a thickness on both sides of 3.5 μm (each 1.75 μm on one side) to prepare a coating layer. Herein, an amount of polyethylene wax particles included in the separator was 1.75 g.

The separator was used in the same manner as in Example 1 to fabricate a half-cell.

### Example 3

A separator for a lithium secondary battery was manufactured in the same manner as in Example 1 except that the coating liquid prepared by Example 1 was die-coated on both sides of a 5.5 μm thickness polyethylene porous substrate to be a thickness on both sides of 3.0 μm (each 1.50 μm on one side) to prepare a coating layer. Herein, an amount of polyethylene wax particles included in the separator was 1.5 g.

The separator was used in the same manner as in Example 1 to fabricate a half-cell.

### Comparative Example 1

A separator for a lithium secondary battery was manufactured in the same manner as in Example 1 except that the coating liquid was prepared by mixing 54.12 g of the boehmite/binder dispersion of Example 1, 0.81 g of polyglycidyl ether curable binder aqueous solution at a concentration of 18.9%, 37.70 g of distilled water, and 7.37 g of a polyacryl amide aqueous solution at a concentration of 8.3%.

The separator was used in the same manner as in Example 1 to fabricate a half-cell.

### Comparative Example 2

A separator for a lithium secondary battery was manufactured in the same manner as in Example 1 except that the coating liquid prepared by Example 1 was die-coated on both sides of a 5.5 μm thickness polyethylene porous substrate to be a thickness on both sides of 2.5 μm (each 1.25 μm on one side) to prepare a coating layer. Herein, an amount of polyethylene wax particles included in the separator was 1.25 g.

The separator was used in the same manner as in Example 1 to fabricate a half-cell.

### Comparative Example 3

A separator for a lithium secondary battery was manufactured in the same manner as in Example 1 except that the coating liquid prepared by Example 1 was die-coated on both sides of a 5.5 μm thickness polyethylene porous substrate to be a thickness on both sides of 2.00 μm (each 1.0 μm on one side) to prepare a coating layer. Herein, an amount of polyethylene wax particles included in the separator was 1.0 g.

The separator was used in the same manner as in Example 1 to fabricate a half-cell.

### Comparative Example 4

A separator for a lithium secondary battery was manufactured in the same manner as in Example 1 except that the coating liquid prepared by Example 1 was die-coated on both sides of a 5.5 μm thickness polyethylene porous substrate to be a thickness on both sides of 1.5 μm (each 1.25 μm on one side) to prepare a coating layer. Herein, an amount of polyethylene wax particles included in the separator was 0.75 g.

The separator was used in the same manner as in Example 1 to fabricate a half-cell.

### Comparative Example 5

A separator for a lithium secondary battery was manufactured in the same manner as in Example 1 except that the coating liquid prepared by Example 1 was die-coated on both sides of a 5.5 μm thickness polyethylene porous substrate to be a thickness on both sides of 1.0 μm (each 0.5 μm on one side) to prepare a coating layer. Herein, an amount of polyethylene wax particles included in the separator was 0.5 g.

The separator was used in the same manner as in Example 1 to fabricate a half-cell.

### Comparative Example 6

A coating liquid was prepared in the same manner as in Example 1 except that a polyethylene (PE) particles aqueous solution using polyethylene particles with a weight average molecular weight of 5000 g/mol at a concentration of 40% (weight average molecular weight (Mw) of polyethylene particles: 5000 g/mol, average particle size (D50) of polyethylene wax: 1 μm, and a melting temperature of the polyethylene wax: 118° C.) was used.

A separator for a lithium secondary battery was manufactured in the same manner as in Example 1 except that the coating liquid prepared by Example 1 was die-coated on both sides of a 5.5 μm thickness polyethylene porous substrate (air permeability: 113 sec/100 cc, puncture strength: 280 kgf, a melting temperature: 143° C., SK ie technology Co., Ltd.) to be a thickness on both sides of 4.0 μm (each 2.0 μm on one side) to prepare a coating layer. Herein, an amount of polyethylene wax particles included in the separator was 2.0 g.

The separator was used in the same manner as in Example 1 to fabricate a half-cell.

### Comparative Example 7

A coating liquid was prepared in the same manner as in Example 1 except that a polyethylene (PE) particles aqueous solution using polyethylene particles with a weight average molecular weight of 10000 g/mol at a concentration of 40% (weight average molecular weight (Mw) of polyethylene particles: 10000 g/mol, average particle size (D50) of polyethylene wax: 1 μm, and a melting temperature of the polyethylene wax: 120° C.) was used.

A separator for a lithium secondary battery was manufactured in the same manner as in Example 1 except that the coating liquid prepared by Example 1 was die-coated on both sides of a 5.5 μm thickness polyethylene porous substrate (air permeability: 113 sec/100 cc, puncture strength: 280 kgf, a melting temperature: 143° C., SK ie technology Co., Ltd.) to be a thickness on both sides of 4.0 μm (each 2.0 μm on one side) to prepare a coating layer. Herein, an amount of polyethylene wax particles included in the separator was 2.0 g.

The separator was used in the same manner as in Example 1 to fabricate a half-cell.

### Comparative Example 8

4.87 g of the boehmite/binder dispersion of Example 1, 32.47 g of a polyethylene (PE) particles aqueous solution at a concentration of 40% (weight average molecular weight (Mw) of polyethylene particles: 1500 g/mol, average particle size (D50) of polyethylene wax: 1 μm, and a melting temperature of the polyethylene wax: 113° C.), 0.81 g of a polyglycidyl ether binder aqueous solution at a concentration of 18.9%, 48.52 g of distilled water, and 7.37 g of a polyacryl amide aqueous solution at a concentration of 8.3% were mixed and then, stirred for 1 hour, preparing a coating liquid.

The coating liquid was die-coated on both sides of a 5.5 μm-thick polyethylene porous substrate (air permeability: 113 sec/100 cc, puncture strength: 280 kgf, a melting temperature: 143° C., SK ie technology Co., Ltd.) at a thickness on both sides of 4 μm (each 2 μm on one side) and then, dried at 70° C. for 10 minutes to form a coating layer with a thickness of 4 μm on both sides.

The separator was used in the same manner as in Example 1 to fabricate a half-cell.

### Comparative Example 9

18.8 g of the boehmite/binder dispersion of Example 1, 32.47 g of a polyethylene (PE) particles aqueous solution at a concentration of 40% (weight average molecular weight (Mw) of polyethylene particles: 1500 g/mol, average particle size (D50) of polyethylene wax: 1 μm, and a melting temperature of the polyethylene wax: 113° C.), 0.81 g of a polyglycidyl ether binder aqueous solution at a concentration of 18.9%, 48.52 g of distilled water, and 7.37 g of a polyacryl amide aqueous solution at a concentration of 8.3% were mixed and then, stirred for 1 hour, preparing a coating liquid.

The coating liquid was die-coated on both sides of a 5.5 μm-thick polyethylene porous substrate (air permeability: 113 sec/100 cc, puncture strength: 280 kgf, a melting temperature: 143° C., SK ie technology Co., Ltd.) at a thickness on both sides of 4 μm (each 2 μm on one side) and then, dried at 70° C. for 10 minutes to form a coating layer with a thickness of 4 μm on both sides.

The separator was used in the same manner as in Example 1 to fabricate a half-cell.

### Experimental Example 1) Evaluation of Physical Properties

### 1) Evaluation of Air Permeability

The air permeability of the separators according to Examples 1 to 3 and Comparative Examples 1 to 9 were measured. The results are shown in Table 1. The air permeability experiment was performed by using an air permeability meter (TYPE EG01-55-1MR, ASAHI-SEICO Co., Ltd.) to measure time (seconds) that it took for 100 cc of air to pass each separator.

### 2) Evaluation of Air Permeability After Heat Exposure

The separators according to Examples 1 to 3 and Comparative Examples 1 to 9 were allowed to stand at 110° C. for 10 minutes, and then the air permeability was measured. The results are shown in Table 1. The air permeability experiment was performed by using an air permeability meter (TYPE EG01-55-1MR, ASAHI-SEICO Co., Ltd.) to measure time (seconds) that it took for 100 cc of air to pass each separator.

### 3) Evaluation of Binding Force

During the manufacturing process of the separators of Examples 1 to 3 and Comparative Examples 1 to 9, each porous substrate with a coating layer was cut into a width of 12 mm and a length of 50 mm to prepare samples. After attaching a tape adhered to a slide glass to the adhesive layer side of each sample, while the tape and the adhesive layer was peeled off therefrom by using a 180 [symbol] UTM tensile strength tester to measure a binding force. Herein, a peeling speed was set at 10 mm/min, and the binding force was three times measured to calculate an average value to obtain a force required for peeling 40 mm after the start of peeling. The results are shown in Table 1.

### 3) Evaluation of Shutdown Temperature

The separators of Examples 1 to 3 and Comparative Examples 1 to 9 were measured with respect to a temperature at which shutdown started by increasing the temperature. The results are shown in Table 1. In Table 1, a fabric panel temperature indicates a shutdown temperature of a polyethylene porous substrate itself.

In Table 1, the thickness represents a total thickness of the prepared separator, the weight represents a weight per m² of the separator, and the density represents a value divided by the loading amount per thickness of the coating layer.

In addition, the amount (g) of polyethylene particle represents an amount of polyethylene particles included in the separator and the polyethylene particles and ceramics (weight ratio) represents a ratio in the coating layer.

TABLE 1

| | | | | Comparative | Comparative | Comparative | Comparative |
|---|---|---|---|---|---|---|---|
| | Example 1 | Example 2 | Example 3 | Example 1 | Example 2 | Example 3 | Example 4 |
| Amount of | 2.00/3.4 | 1.75/3.4 | 1.5/3.4 | 0.00/3.40 | 1.25/3.4 | 1.00/3.4 | 0.75/3.4 |
| polyethylene | | | | | | | |
| particles (g)/ | | | | | | | |
| weight of porous | | | | | | | |
| substrate (g) | | | | | | | |
| Amount of | 58.8 | 51.5 | 44.1 | — | 36.8 | 29.4 | 22.1 |
| polyethylene | | | | | | | |
| particles based | | | | | | | |
| on weight of | | | | | | | |
| porous substrate | | | | | | | |
| (wt %) | | | | | | | |
| Weight average | 1500 | 1500 | 1500 | — | 1500 | 1500 | 1500 |
| molecular weight | | | | | | | |
| of polyethylene | | | | | | | |
| particle (g/mol) | | | | | | | |
| Polyethylene | 80:20 | 80:20 | 80:20 | 0:100 | 80:20 | 80:20 | 80:20 |
| particle:ceramics | | | | | | | |
| (weight ratio) | | | | | | | |
| Thickness (μm) | 10.5 | 10.0 | 9.5 | 10.5 | 9.0 | 8.5 | 8.0 |
| Air permeability | 210 | 205 | 201 | 162 | 194 | 188 | 181 |
| (sec/100 cc) | | | | | | | |
| Weight g/m² | 6.56 | 6.26 | 5.96 | 7.10 | 5.81 | 5.66 | 5.36 |
| Density g/m³ | 0.63 | 0.62 | 0.60 | 0.74 | 0.61 | 0.62 | 0.63 |
| Binding force | 4.81 | 4.74 | 4.67 | 5.44 | 4.70 | 4.74 | 4.84 |
| (gf/mm) | | | | | | | |
| Shutdown | 114 | 115 | 116 | 151 | 122 | 128 | 133 |
| temperature (° C.) | | | | | | | |
| [fabric 146° C.] | | | | | | | |
| Air permeable | 9534 | 9387 | 9223 | 162 | 6163 | 3103 | 1708 |
| time after | | | | | | | |
| allowing to stand | | | | | | | |
| at 110° C. for 10 | | | | | | | |
| minutes | | | | | | | |
| (sec/100 cc) | | | | | | | |

| | Comparative | Comparative | Comparative | Comparative | Comparative |
|---|---|---|---|---|---|
| | Example 5 | Example 6 | Example 7 | Example 8 | Example 9 |
| Amount of | 0.50/3.4 | 2.00/3.4 | 2.00/3.4 | 2.00/3.4 | 2.00/3.4 |
| polyethylene | | | | | |
| particles (g)/ | | | | | |
| weight of porous | | | | | |
| substrate (g) | | | | | |
| Amount of | 14.7 | 58.8 | 58.8 | 58.8 | 58.8 |
| polyethylene | | | | | |
| particles based | | | | | |
| on weight of | | | | | |
| porous substrate | | | | | |
| (wt %) | | | | | |
| Weight average | 1500 | 5000 | 10000 | 1500 | 1500 |
| molecular weight | | | | | |
| of polyethylene | | | | | |
| particle (g/mol) | | | | | |
| Polyethylene | 80:20 | 80:20 | 80:20 | 90:10 | 70:30 |
| particle:ceramics | | | | | |
| (weight ratio) | | | | | |
| Thickness (μm) | 7.5 | 10.5 | 10.5 | 10.5 | 10.5 |
| Air permeability | 175 | 215 | 212 | 235 | 202 |
| (sec/100 cc) | | | | | |
| Weight g/m² | 5.06 | 6.60 | 6.65 | 6.35 | 6.77 |
| Density g/m³ | 0.64 | 0.65 | 0.67 | 0.55 | 0.69 |
| Binding force | 4.93 | 4.74 | 4.71 | 4.10 | 5.38 |
| (gf/mm) | | | | | |
| Shutdown | 138 | 124 | 130 | 114 | 120 |
| temperature (° C.) | | | | | |
| [fabric 146° C.] | | | | | |
| Air permeable | 314 | 6163 | 5230 | 9345 | 9266 |
| time after | | | | | |
| allowing to stand | | | | | |
| at 110° C. for 10 | | | | | |
| minutes | | | | | |
| (sec/100 cc) | | | | | |

As shown in Table 1, the separator of Examples 1 to 3 exhibited lower binding force than Comparative Example 1 without polyethylene particles, but longer air permeable time when it was allowed to stand at a high temperature than Comparative Example 1, and lower shutdown temperature which indicates excellent shutdown effect. Furthermore, Examples 1 to 3 exhibited suitable air permeability (room temperature) of 210 seconds/100 cc.

Whereas, Comparative Examples 2 to 5 including a small amount of polyethylene particles, less than 40 wt % based on the amount of the porous substrate, exhibited a high shutdown temperature, particularly, exceeding 116° C. which was an appropriate temperature as the separator and had a short air permeable time when it was allowed to stand at a high temperature.

Furthermore, even though polyethylene particles were used, Comparative Examples 6 and 7 using polyethylene with high weight-average molecular weight of 5000 g/mol and 10000 g/mol, exhibited extremely high shutdown temperatures and the air permeability (room temperature) of more than 210 seconds which was an appropriate value as the separator.

Comparative Example 8 using polyethylene particles at an excess amount, i.e., the mixing ratio of polyethylene particle and the ceramics being 90:10 by weight ratio exhibited the air permeability of 235 seconds which was extremely high and Comparative Example 9 using polyethylene particles at a small amount, i.e., the mixing ratio of polyethylene particles and the ceramics of 70:30 by weight ratio exhibited the shutdown temperature of more than 116° C. which was appropriate as the separator.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims. Therefore, the aforementioned embodiments should be understood to be exemplary but not limiting the present invention in any way.

1. A separator for a rechargeable lithium battery, the separator comprising:
a porous substrate; and
a coating layer positioned on at least one surface of the porous substrate and comprising polyethylene particles and ceramics,
wherein an amount of the polyethylene particles is 40 wt % to 65 wt % of the weight of the porous substrate,
a weight average molecular weight (Mw) of the polyethylene particles is 1000 g/mol to 3000 g/mol, and
a mixing ratio of the polyethylene particles to the ceramics is 95:5 to 80:20 by weight ratio.

2. The separator for a rechargeable lithium battery as claimed in claim 1, wherein the polyethylene particles have an average size of 0.1 μm to 3.0 μm.

3. The separator for a rechargeable lithium battery as claimed in claim 1, wherein the coating layer has a thickness of 0.5 μm to 5 μm.

4. The separator for a rechargeable lithium battery as claimed in claim 1, wherein the ceramics have an average size of 0.5 μm to 3.0 μm.

5. The separator for a rechargeable lithium battery as claimed in claim 1, wherein the ceramics comprise at least one of Al2O3, SiO2, TiO2, SnO2, CeO2, MgO, NiO, CaO, GaO, ZnO, ZrO2, Y2O3, SrTiO3, BaTiO3, Mg(OH)2, and boehmite.

6. The separator for a rechargeable lithium battery as claimed in claim 1, wherein the coating layer further comprises a binder.

7. The separator for a rechargeable lithium battery as claimed in claim 6, wherein the binder comprises at least one of a dispersion binder, a curable binder, and an aqueous binder.

8. The separator for a rechargeable lithium battery as claimed in claim 7, wherein the dispersion binder comprises at least one of sodium polyacrylate, ammonium polyacrylate, and potassium polyacrylate.

9. The separator for a rechargeable lithium battery as claimed in claim 7, wherein the aqueous binder comprises at least one of a styrene-butadiene rubber, an acrylated styrene-butadiene rubber, polyvinyl alcohol, sodium polyacrylate, a copolymer of propylene and a C2 to C8 olefin, poly acryl amide, and a copolymer of (meth)acrylic acid and (meth)acrylic acid alkyl ester.

10. The separator for a rechargeable lithium battery as claimed in claim 7, wherein the curable binder comprises at least one of polyglycidyl ether, isocyanate, epoxy, an acryl-based copolymer, and a fluorine-included binder.

11. The separator for a rechargeable lithium battery as claimed in claim 1, wherein the separator further comprises an adhesive layer on one surface of the coating layer.

12. The separator for a rechargeable lithium battery as claimed in claim 1, wherein the adhesive layer has a thickness of 0.1 μm to 4.0 μm on one side.

13. The separator for a rechargeable lithium battery as claimed in claim 11, wherein the adhesive layer comprises a binder and a filler.

14. The separator for a rechargeable lithium battery as claimed in claim 13, wherein the binder comprises at least one of (meth)acrylic acid, (meth)acrylate, (meth)acrylonitrile, (meth)acrylamidosulfonic acid, a (meth)acrylamidosulfonate salt, styrene, ethylhexyl acrylate, and a copolymer thereof.

15. The separator for a rechargeable lithium battery as claimed in claim 13, wherein the filler comprises at least one of polyvinylidene fluoride, a polyvinylidene fluoride-hexafluoropropylene copolymer, and polytetrafluoroethylene.

16. A rechargeable lithium battery, comprising:
a negative electrode comprising a negative active material;
a positive electrode comprising a positive active material;
the separator as claimed in claim 1 between the negative electrode and the positive electrode; and
a non-aqueous electrolyte.
